(19) United States
(12) Patent Application Publication
(10) Pub. No.: US 2021/0226395 A1
(43) Pub. Date: Jul. 22, 2021

(54) PLUG CONNECTOR

(71) Applicant: HARTING Electric GmbH & Co. KG, Espelkamp (DE)

(72) Inventor: Felix LOSKE, Lotte (DE)

(21) Appl. No.: 16/095,903

(22) PCT Filed: May 30, 2017
(86) PCT No.: PCT/DE2017/100457

§ 371 Date: Oct. 23, 2018

(30) Foreign Application Priority Data
May 31, 2016 (DE) 10 2016 109 989.9

(51) Int. Cl. H01R 35/04; H01R 39/64; H01R 13/512; H01R 25/00

(52) U.S. Cl. CPC H01R 35/04; H01R 25/003; H01R 13/512; H01R 39/643

(57) ABSTRACT

Disclosed is a plug connector for contacting electrical lines. The plug connector has a first plug part and a second plug part. The first plug part and the second plug part are each designed for receiving and contacting of an electrical cable. The first plug part has a spherical shell as a contact region and the second plug part has a sphere as a contact region. By this geometric design, the first plug part and the second plug part can be variably aligned and fastened to each other. Particularly advantageously and flexible, the first plug part and the second plug part can be adjusted without the contact and connections having to be dismantled.

The invention starts with a plug connector according to the precharacterizing clause of the independent claim 1.

Plug connectors of this type are required to preferably reversibly and repeatably connect electrical lines or cables to one another. Plug connectors mostly comprise a plug and a mating plug. Plugs and mating plugs possess mutually corresponding contact elements which are connected in each case to the lines or cables to be connected. If plugs and mating plugs are connected to one another, the corresponding contacts come into contact and thus establish a conductive connection between the lines or cables.

DE 92 15 225 U1 discloses a plug connector housing for contacting with a mating plug connector. The plug connector housing has a housing connection piece through which a cable can be guided into the plug connector housing. The cable can be fastened and sealed to the housing connection piece by means of a screw connection.

A plug connector housing for clamping and curving an electrical cable connected to a plug connector is known from EP 2 323 228 B1. The plug connector housing is formed by an insulating body and an angled strain relief element which can be releasably fastened thereto in different alignments. The strain relief element has a receiving sleeve, which is provided with a thread, and a pressure screw.

In the case of the plug connectors and plug connector housings known from the prior art, it is disadvantageous that the cables exit the plug connector in a defined direction. Although EP 2 323 228 B1 offers a solution which defines different exit directions, these cannot be altered at will. To alter the exit direction, the plug connector must be dismantled and the cable released. Only then can the alignment of the cable exit be altered and the plug connector reassembled. Altering the cable exit direction is consequently very time-consuming and laborious.

The invention is therefore based on the object of providing a plug connector in which the exit direction of the cable is freely adjustable. In this case, it should be possible to vary the exit direction without much effort and the plug connector and connected cables should not have to be dismantled for this.

The object is achieved by the characterizing features of the independent claim 1.

Advantageous configurations of the invention are revealed in the subclaims.

The invention relates to a plug connector having a first plug part and a second plug part, wherein the first plug part has at least one first contact point and at least one first contact face and in that the second plug part has at least one second contact point and at least one second contact face. A first contact point forms a contact pair with a second contact face in each case and a second contact point forms a contact pair with a first contact face in each case. This is preferably a plug connector for the transfer of electrical currents and the contacting of electrical lines.

In this case, the first plug part and the second plug part refer to a first plug partner and second plug partner of the plug connector. Therefore, one of the plug parts is the female plug and the other plug part is the male mating plug.

The contact points are formed as so-called end-pressure contacts and enable an approximately punctiform contact. On the other hand, the contact faces form a planar region which can be used as a contact. A contact can be established at any point of the contact face. The contact pair—formed by the contact point and the contact face—is consequently movable with respect to one another. The contact point can be moved over the contact face without breaking the contact between the contact point and the contact face. In the case of electrical contacts, permanent contacting is thus possible even though the contacts (contact point and contact face) are moved with respect to one another.

According to the invention, the first plug part is formed by a first base body, wherein the first contact points and the first contact faces are arranged on the first base body, and the second plug part is formed by a second base body, wherein the second contact points and the second contact faces are arranged on the second base body.

This means that each of the two plug parts possess both contact faces and contact points. In this case, the respective contact faces of the first plug part correspond to the contact points of the second plug part. In this case, the respective contact faces of the second plug part correspond to the contact points of the first plug part. This arrangement enables a relative movement of the first plug part with respect to the second plug part, wherein the respective contact pairs, comprising a contact face and a contact point in each case, always remain in electrical contact.

The first base body expediently possesses a first cable exit and the second base body expediently possesses a second cable exit. Electrical cables can be inserted into the base body, and thus into the first and second plug part, via the cable exits in each case and can be connected to said plug part such that they are sealed from the environment.

The inserted cables are electrically connected to the contact faces and contact points in the respective plug parts. For this, the cable preferably comprises a plurality of electrical strands or lines. These are connected to a contact point or to a contact face in each case. The connection can be realized by soldering, but also by a cable clamp, a screw connection or other devices known from the prior art.

According to the invention, the first base body is formed as a spherical shell and possesses a spherical inside face. The contact points and contact faces of the first plug part are formed and/or arranged on the spherical inside face. In the best case here, the spherical shell is a hemisphere. Also, a construction which is somewhat smaller than a hemisphere, or slightly larger, can still be realized.

The second base body is formed as a sphere and possesses a spherical outside face. The contact points and contact faces of the second plug part are formed and/or arranged on the spherical outside face.

According to the invention, the spherical inside face of the first base body and the spherical outside face of the second base body are dimensioned such that a gap is formed between the spherical inside face and the spherical outside face. The gap serves such that the first contact faces do not contact the second contact faces and thereby create a short-circuit.

An advantageous embodiment provides for arranging at least one spacer in the gap, wherein the spacer is electrically insulating. The spacer thus defines the gap between the spherical inside face and the spherical outside face. The first plug part and the second plug part are thus always arranged at the defined spacing from one another and can be moved and rotated with respect to one another.

In a preferred embodiment, the invention provides that the contact points of the first plug part and the second plug part are mounted to be resilient along their axis. Contacts of this type are also known from the prior art as end-pressure contacts or Pogo contacts/pins. The contact points are expediently arranged between two contact faces on the first plug part or second plug part in each case and project beyond the contact faces. The projection of the contact points beyond the contact faces is preferably greater than the thickness of the gap between the spherical inside face and the spherical outside face. It is thus ensured that the contact points always enable electrical contacting of the associated contact face of the other plug part.

According to the invention, the contact faces and the contact points of a plug part in each case are electrically insulated from one another. Different signals can thus be transmitted via the respective contacts without generating short circuits.

In an advantageous further development of the invention, the plug connector furthermore possesses a fastening means, which can fasten the first plug part and the second plug part to one another. The fastening means is expediently formed as a ring and possesses a thread, for example, for screwing to one of the plug parts. The plug parts are pressed against one another and thus fastened to one another by the screwing procedure.

Alternative embodiments provide for securing the fastening means to one of the plug parts by means of a clamping ring. In this case, the clamping ring reaches at least partially around both plug parts and thus fastens these to one another. It would also be expedient to clamp the fastening means directly to one of the plug parts via a clamping device, wherein the further plug part is fastened and clamped between the fastening means and the plug part.

The fastening means is preferably fastened to the first plug part. In this case, the fastening means reaches over the second plug part formed as a sphere and presses it onto the first plug part, into the spherical shell of the first plug part.

A further preferred embodiment provides for configuring the plug connector to be water-tight. A membrane is provided for this, which stretches around the second plug part and protects it against liquids, dust and other environmental influences. In the upper region, the membrane is fastened to or by the cable exit of the second plug part. In the lower region, the membrane is fastened to or by the fastening means. The membrane is thus stretched over the entire second plug part and protects this. In a particularly preferred embodiment, the membrane is formed by an elastic polymer. The relative movement of the first plug part with respect to the second plug part can be compensated by the elastic polymer so that the membrane always lies tightly against the second plug part.

The plug connector according to the invention can be fitted with a smaller or greater number of contact pairs depending on the construction. The greater the number of contact pairs—comprising contact points and contact faces—arranged on the spherical inside and spherical outside faces, the necessarily smaller the construction of the contact faces. The smaller the form of the contact faces, the smaller the pivotal and rotational range in which the plug parts can be rotated with respect to one another. In the case in which a plug connector according to the present invention has few contacts, the flexibility of the movement of the plug parts is correspondingly greater than in the case in which a plug connector has a large number of contacts.

The plug connector according to the invention has a spherical head joint, by means of which the first plug part and the second plug part of the plug connector are connected. In this case, the first contacts—comprising first contact points and first contact faces—and the second contacts—comprising second contact points and second contact faces—are arranged in the spherical head and a spherical head socket of the spherical head joint such that they are electrically contacted in each position of the spherical head joint. In contrast to the solutions known from the prior art, the contact region itself is the joint, which enables a variable cable exit.

The advantages of the invention consist in particular in that the contact points and contact faces of each contact pair are arranged to be movable with respect to one another. The first plug part and the second plug part can thus be moved and rotated with respect to one another. The object according to the invention is thus achieved in that an alignment of the cable exits of the first and second plug parts with respect to one another is enabled. The plug parts can be aligned and fastened in a desired position with respect to one another. In the case of a new alignment, the entire plug connector does not have to be newly assembled or fitted. Only the plug parts have to be newly aligned and fastened. The object according to the invention is thus achieved particularly advantageously.

### EXEMPLARY EMBODIMENT

An exemplary embodiment of the invention is illustrated in the drawings and will be explained in more detail below. The drawings show:

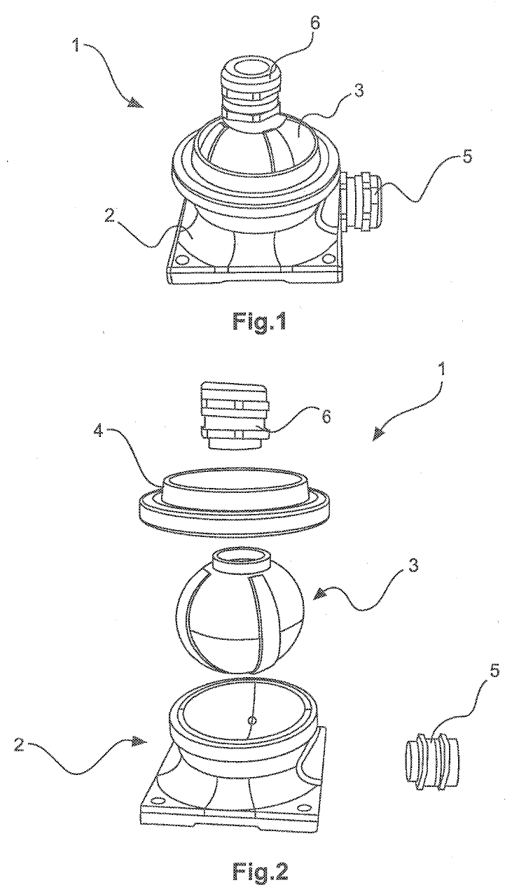

FIG. 1 a perspective illustration of a plug connector according to the present invention;

FIG. 2 an exploded view of a plug connector according to the invention;

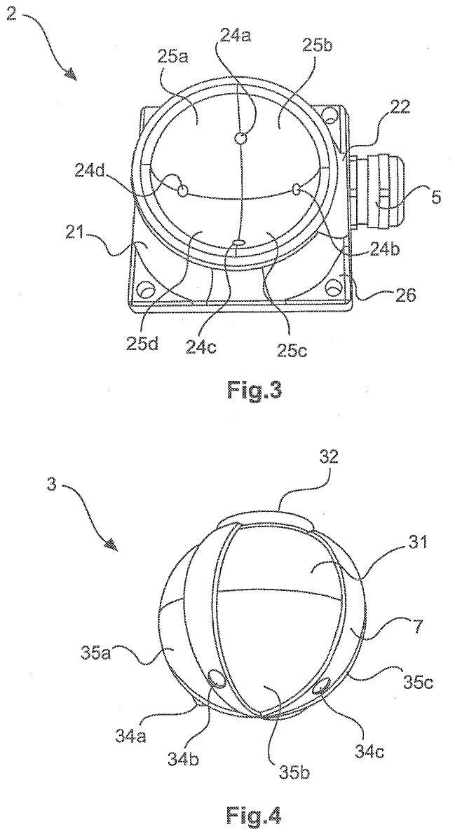

FIG. 3 a first plug part;

FIG. 4 a second plug part;

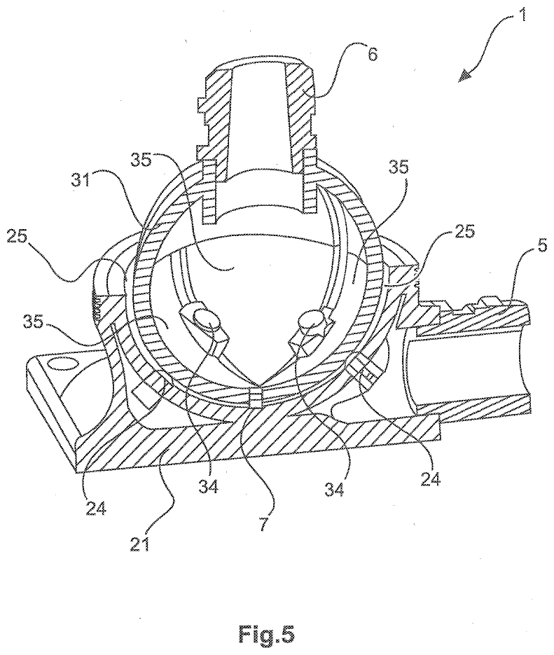

FIG. 5 a sectional illustration of a plug connector according to the invention; and

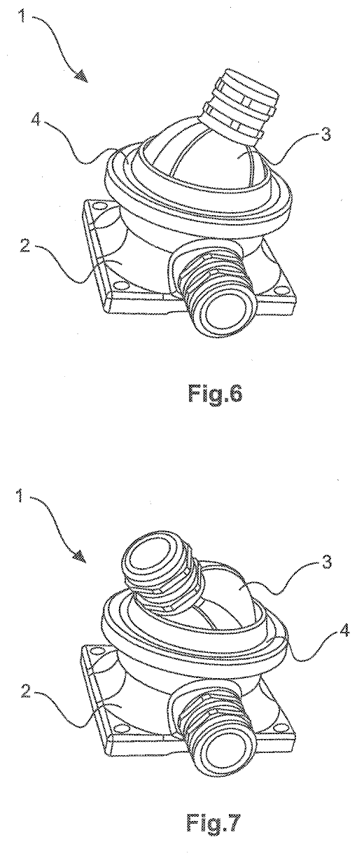

FIGS. 6 and 7 the plug connector of FIG. 1 in two further positions.

The figures contain partially simplified schematic illustrations. Identical reference signs are sometimes used for elements which are similar but possibly not identical. Varying views of similar elements can be drawn to different scales.

FIG. 1 shows a perspective illustration of a plug connector 1 according to the present invention. The plug connector 1 is formed by a first plug part 2 and a second plug part 3. In this case, the first plug part 2 and the second plug part 3 each have a cable exit 5, 6, through which a respective cable can be guided into the plug parts and connected there. In this case, the first plug part 2 is formed with a flange. The flange possess four—in this case two visible—openings by means of which the first plug part 2 can be screwed and secured on a surface or to a housing.

The second plug part 3 is received in the first plug part 2 and is movably arranged therein. The cable exit 6 of the second plug part 3 can thus be variably aligned on the plug connector 1 and with respect to the first plug part 2.

In FIG. 2, the plug connector 1 is shown in an exploded illustration with its individual parts. Illustrated at the bottom is the first plug part 2, which is formed as a spherical shell and serves as a socket for the second plug part 3 illustrated above. The second plug part 3 is formed as a sphere and is insertable into the first plug part 2 and movably received therein.

Both plug parts 2, 3 possess a cable exit 5, 6. The cable exit 5 is arranged in a lateral opening on the first plug part 2. A cable can be inserted into the plug part 2 via the cable exit 5. A cable can be correspondingly inserted into the second plug part 3 via the cable exit 6. The cable exit 6 is located above the second plug part 3.

A fastening means 4 is arranged over the second plug part 3. The fastening means 4 is formed as a screw ring and is provided for screwing onto the first plug part 2. For this, the fastening means 4 can reach around the second plug part 4 and thus fasten it in the first plug part 2. The second plug part 4 is thus received in the first plug part 2 and prevented from falling out by the fastening means 4 and equally, depending on the extent to which the fastening means 4 is to be secured to the first plug part 2, also immovably fastened in a defined position between the first plug part 2 and the fastening means 4.

An isolated first plug part 2 is shown in FIG. 3. In this case, the first plug part 2 is formed by a first base body 21. The base body 21 possesses a lateral opening 22 in which the cable exit 5 is received. A cable can be inserted into the first plug part 2 via the cable exit 5 and the opening 22.

On the underside, a flange 26 is integrally formed on the base body 21. The flange 26 possesses four bores by means of which the base body 26 can be secured on a housing or another surface.

According to the invention, the first base body 21 is formed as a spherical shell. In this case, the first base body 21 forms a spherical inside face, which corresponds to a hemisphere. In the exemplary embodiment shown, four first contact faces 25a, 25b, 25c, 25d are formed on the spherical inside face, as well as four first contact points 24a, 24b, 24c, 24d, arranged between the first contact faces 25a, 25b, 25c, 25d. In this case, the first contact points 24a, 24b, 24c, 24d and first contact faces 25a, 25b, 25c, 25d are electrically insulated from one another, wherein the first contact points 24a, 24b, 24c, 24d are formed such that they are raised slightly above the first contact faces 25a, 25b, 25c, 25d.

Strands or wires of an inserted electrical cable can be electrically connected to the first contact points 24a, 24b, 24c, 24d and first contact faces 25a, 25b, 25c, 25d in the interior of the first base body 21. An electrical connection of the first contacts 24a, 24b, 24c, 24d, 25a, 25b, 25c, 25d to the connected cable is thus established.

The second plug part 3 is illustrated in isolation in FIG. 4. This plug part comprises a second base body 31, which forms a sphere. The second base body 31 consequently has a spherical outside face on which the second contact points 34a, 34b, 34c, 34d and the second contact faces 35a, 35b, 35c, 35d are arranged. In this case, the second contact points 34a, 34b, 34c, 34d and the second contact faces 35a, 35b, 35c, 35d are electrically insulated from one another. The second contact points 34a, 34b, 34c, 34d are arranged such that they are raised slightly above the second contact faces 35a, 35b, 35c, 35d.

In the exemplary embodiment shown, spacers 7 are arranged between the second contact faces 35a, 35b, 35c, 35d on the spherical outside face of the second base body 31. The electrically insulating spacers 7 are raised above the second contact faces 35a, 35b, 35c, 35d but do not project beyond the second contact points 34a, 34b, 34c, 34d. The spacers 7 merely define a gap between the spherical inside face of the first plug part 2 and the spherical outside face of the second plug part 3, i.e. between the first contact faces 25a, 25b, 25c, 25d and the second contact faces 35a, 35b, 35c, 35d.

In the region of the second plug part 3 which is illustrated at the top, an opening 32 is also integrally formed on the base body 3, which opening is provided for receiving the cable exit 6. In the interior of the second base body 31, strands or wires of an inserted electrical cable can be electrically connected to the second contact points 34a, 34b, 34c, 34d and second contact faces 35a, 35b, 35c, 35d. An electrical connection of the second contacts 34a, 34b, 34c, 34d, 35a, 35b, 35c, 35d to the connected cable is thus established.

FIG. 5 shows a sectional illustration of a plug connector 1 according to the invention. The second base body 31 of the second plug part 3 is received in the spherical shell of the first base body 21. In this case, the first contact points 24 of the first plug part 2 contact the second contact faces 35 of the second plug part 3. Likewise, the first contact faces 25 of the first plug part 2 are contacted by the second contact points 34 of the second plug part 3.

The gap between the spherical inside face of the first plug part 2 and the spherical outside face of the second plug part 3 is defined by the spacers 7. These can be seen in the lower region of the second plug part 3. Distributed over the circumference of the second base body 31, the spacers 7 are arranged between the second contact faces 35 and, at the same time, separate these in an electrically insulating manner

It can moreover be seen in FIG. 5 how the cable exits 5, 6 enable entry of a cable into the interior of the base body 21, 31. There, the strands/wires of the cables can be connected in an electrically conductive manner to the first and second contacts 24, 24a, 24b, 24c, 24d, 25, 25a, 25b, 25c, 25d, 34, 34a, 34b, 34c, 34d, 35, 35a, 35b, 35c, 35d. The connection of the strands/wires to the contacts 24, 24a, 24b, 24c, 24d, 25, 25a, 25b, 25c, 25d, 34, 34a, 34b, 34c, 34d, 35, 35a, 35b, 35c, 35d is not described further here, since this is already widely known from the prior art.

For the sake of clarity, the illustration of the fastening means 4 has been omitted in FIG. 5. Screwed to the first plug part 2 in the upper region thereof, this fastening means would surround the second plug part 3, at least in certain regions, and press it into the spherical shell of the first plug part 2. The first plug part 2 and the second plug part 3 can thus be connected to one another via form fit and fastened to one another via force fit.

The plug connector 1 of FIG. 1 is illustrated in two further positions in FIGS. 6 and 7. In this case, the second plug part 3 in FIG. 6 is pivoted rearward to the right and fastened. In FIG. 7, the second plug part 3 is pivoted forward to the left and fastened. The two plug parts 2, 3 can thus be moved in diverse positions with respect to one another and fastened with respect to one another via the fastening means 4. The maximum pivotal range of the second plug part 3 is approximately 45° in any direction, starting from the perpendicularly projecting cable exit 6 of FIG. 1. Moreover, the second plug part 3 can be rotated through approximately 40°-45° starting from FIG. 1. The maximum deflection and rotation of the first plug part 2 and second plug part 3 with respect to one another depends on the number of contact pairs and the width of the spacers 7. This means that the plug connecter 1 can be aligned with greater flexibility, the fewer contact pairs it has. Correspondingly, the flexibility becomes more limited, the more contact pairs are present.

1. A plug connector, having a first plug part and a second plug part, wherein
the first plug part has at least one first contact point and at least one first contact face and in that the second plug part has at least one second contact point and at least one second contact face, wherein a first contact point and a second contact face form a contact pair in each case and a second contact point and a first contact face form a contact pair in each case.

2. The plug connector as claimed in claim 1, wherein
the first plug part is formed by a first base body, wherein the first contact points and the first contact faces are arranged on the first base body, and in that the second plug part is formed by a second base body, wherein the second contact points and the second contact faces are arranged on the second base body.

3. The plug connector as claimed in claim 2, wherein
the first base body has a first cable exit and/or the second base body has a second cable exit.

4. The plug connector as claimed in claim 2, wherein,
the first base body is formed as a spherical shell with a spherical inside face, wherein the first contact points and first contact faces are formed on the spherical inside face.

5. The plug connector as claimed in claim 2,
the second base body is formed as a sphere with a spherical outside face, wherein the second contact points and the second contact faces are formed on the spherical outside face.

6. The plug connector as claimed in claim 1,
the plug connector has at least one electrically insulating spacer, which is arranged between the first plug part and the second plug part.

7. The plug connector as claimed in claim 6, wherein
the spacer forms a gap between the first contact faces and the second contact faces.

8. The plug connector as claimed in claim 1, wherein
the first and second contact points are arranged between two first and second contact faces in each case.

9. The plug connector as claimed in claim 1,
the first and second contact points are resiliently mounted end-pressure contacts or so-called Pogo pins.

10. The plug connector as claimed in claim 1, wherein
the first contact points and first contact faces are electrically insulated from one another, and
in that the second contact points and second contact faces are electrically insulated from one another.

11. The plug connector as claimed in claim 1, wherein
the first and second contact points are movable on the second and first contact face which form their contact pair.

12. The plug connector as claimed in claim 1, wherein
the plug connector has a fastener,
wherein the first plug part and the second plug part are configured to be fastened to one another by the fastener.

13. The plug connector as claimed in claim 12, wherein
the fastener is formed as a ring and has a thread, wherein the thread is configured to be screwed on the first plug part or the second plug part.

14. The plug connector as claimed in claim 12, wherein
the fastener is formed as a clamping ring and possesses a clamp, wherein the first plug part and the second plug part are configured to be connected by the clamping ring.

15. The plug connector as claimed in claim 12, wherein
the fastener is configured to be fastened to the first plug part by at least one clamping element.

16. The plug connector as claimed in claim 1, wherein
a membrane is on the plug connector, which membrane surrounds the second plug part completely.

17. A plug connector, having a first plug part with first contacts and a second plug part with second contacts, wherein
the first plug part and the second plug part are connected to one another via a spherical head joint.

18. The plug connector as claimed in claim 3,
wherein
the first base body is formed as a spherical shell with a spherical inside face,
wherein the first contact points and first contact faces are formed on the spherical inside face.

19. The plug connector as claimed in claim 3,
wherein
the second base body is formed as a sphere with a spherical outside face,
wherein the second contact points and the second contact faces are formed on the spherical outside face.

20. The plug connector as claimed in claim 4,
wherein
the plug connector has at least one electrically insulating spacer, which is arranged between the first plug part and the second plug part.
